(19) United States
(12) Patent Application Publication
(10) Pub. No.: US 2026/0328733 A1
(43) Pub. Date: Oct. 22, 2026

(54) DEFECT DETECTING METHOD FOR SEALANT PRODUCT AND DEFECT POSITIONING METHOD

(71) Applicant: NATIONAL TSING HUA UNIVERSITY, HSINCHU (TW)

(72) Inventors: Yuan YAO, Hsinchu (TW); Wei-Yang CHUNG, Hsinchu (TW)

(21) Appl. No.: 19/553,443

(22) Filed: Mar. 2, 2026

Related U.S. Application Data
(60) Provisional application No. 63/790,738, filed on Apr. 18, 2025.

(51) Int. Cl. G01N 29/44; G01N 29/06; G01N 29/26

(52) U.S. Cl. CPC G01N 29/4427; G01N 29/069; G01N 29/26; G01N 2291/0289

(57) ABSTRACT

A defect detecting method for a sealant product includes the steps as follows. A plurality of ultrasonic scans are performed on the sealant product to obtain a set of scanning data, and the set of scanning data includes a plurality of longitudinal sliced data and a plurality of transversely sliced data. The set of scanning data is standardized to obtain a set of standardized scanning data, and the set of standardized scanning data includes a plurality of standardized longitudinal sliced data and a plurality of standardized transversely sliced data. The set of standardized scanning data is analyzed by a principal component analysis to obtain a covariance matrix. A determinant of the covariance matrix is compared with a determinant of a standard so as to obtain a defect detecting result.

### RELATED APPLICATIONS

This application claims priority to U.S. Provisional Application Ser. No. 63/790,738, filed Apr. 18, 2025, which is herein incorporated by reference.

### BACKGROUND

### Technical Field

The present disclosure relates to a defect detecting method for a product and a defect positioning method. More particularly, the present disclosure relates to a defect detecting method for a sealant product and a defect positioning method.

### Description of Related Art

The quality inspection of commercial sealant products is usually performed based on the standard test method of ASTM C1183 with a visual inspection. In the standard test method of ASTM C1183, it is necessary to squeeze out the sealant from the package of the sealant product for testing. However, the squeezed out sealant cannot be recycled, and would cause the material loss during the quality inspection. Moreover, a great amount of manpower and time are consumed during the quality inspection, which is unfavorable for the fluency and the production efficiency of the production process. Some industry players perform the quality inspection through sampling in the production process to reduce the material loss in the quality inspection, but it is difficult to ensure the reliability of product quality.

Non-destructive testing (NDT) methods are developed in order to reduce the material loss during the quality inspection. The common non-destructive testing methods are X-ray inspection and thermal imaging inspection. However, the image contrast of bubbles in the X-ray image of the sealant product is low, so that it is difficult to identify defects caused by bubbles in the sealant product by the X-ray inspection. Moreover, the temperature change in the thermal imaging inspection may cause chemical reactions in the sealant product and shorten the shelf time of the sealant product, and the recognition of the thermal imaging inspection is poor in thicker samples. Therefore, an ultrasonic detecting method is developed in order to overcome weak points of the X-ray inspection and the thermal imaging inspection. The ultrasonic detecting method can efficiently detect thicker sealant products with bubbles, but the ultrasonic detecting results are influenced by material properties of the sealant products, and the ultrasonic signals are weakened, so that it is difficult to distinguish the ultrasonic signals from noises.

Therefore, developing a defect detecting method for a sealant product and a defect positioning method with using the ultrasonic scan and the principal component analysis to enhance the interpretation of detecting signals so as to avoid the material loss in the quality inspection and to ensure the reliability of the quality inspection, has been the main goal of the industry.

### SUMMARY

According to one aspect of the present disclosure, a defect detecting method for a sealant product includes steps as follows. A plurality of ultrasonic scans are performed on the sealant product to obtain a set of scanning data, and the set of scanning data includes a plurality of longitudinal sliced data and a plurality of transversely sliced data. The set of scanning data is standardized to obtain a set of standardized scanning data, and the set of standardized scanning data includes a plurality of standardized longitudinal sliced data and a plurality of standardized transversely sliced data. The set of standardized scanning data is analyzed by a principal component analysis to obtain a covariance matrix. A determinant of the covariance matrix is compared with a determinant of a standard so as to obtain a defect detecting result. Each of the ultrasonic scans includes steps as below. The sealant product is scanned from one end of the sealant product to the other end of the sealant product along a long axis of the sealant product by an ultrasonic probe. The sealant product is axially rotated with a rotating angle of 1 degree to 180 degrees.

According to another aspect of the present disclosure, a defect positioning method includes steps as follows. The defect detecting result of the defect detecting method for the sealant product of the aforementioned aspect is converted to a score plot, and the score plot includes a plurality of skewness sequences. The skewness sequences are mapped corresponding to the longitudinal sliced data and the transversely sliced data so as to obtain a defect positioning result.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a defect detecting method for a sealant product according to one embodiment of the present disclosure.

FIG. 2 is a schematic view of an ultrasonic testing system used in the defect detecting method for the sealant product in FIG. 1.

FIG. 3 is an enlarged view of zone A in FIG. 2.

FIG. 4 is a flow chart of a defect positioning method according to another embodiment of the present disclosure.

FIG. 5A is a schematic view of the sealant product and longitudinal slices.

FIG. 5B is a schematic view of the sealant product and transversely slices.

FIG. 6 is the flow chart of data analysis according to the defect detecting method for the sealant product and the defect positioning method.

FIG. 7 is three dimensional images of Standard, Experimental example 1, Experimental example 2, Experimental example 3 and Experimental example 4.

FIG. 8A is a score plot of the longitudinal sliced data of Standard, Experimental example 1, Experimental example 2, Experimental example 3 and Experimental example 4.

FIG. 8B is a score plot of the transversely sliced data of Standard, Experimental example 1, Experimental example 2, Experimental example 3 and Experimental example 4.

FIG. 9A is a score plot of the transversely sliced data according to Experimental example 4 in FIG. 8B.

FIG. 9B is a partial enlarged view of the three dimensional image according to Experimental example 4 in FIG. 7.

### DETAILED DESCRIPTION

The present disclosure will be further exemplified by the following specific embodiments. However, the embodiments can be applied to various inventive concepts and can be embodied in various specific ways. The specific embodiments are only for the purposes of description, and are not limited to these practical details thereof.

### <Defect Detecting Method for Sealant Product>

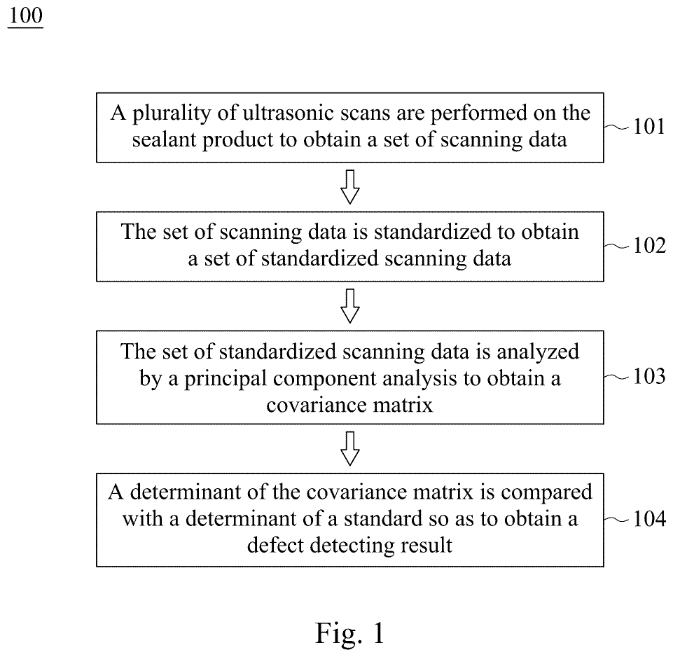

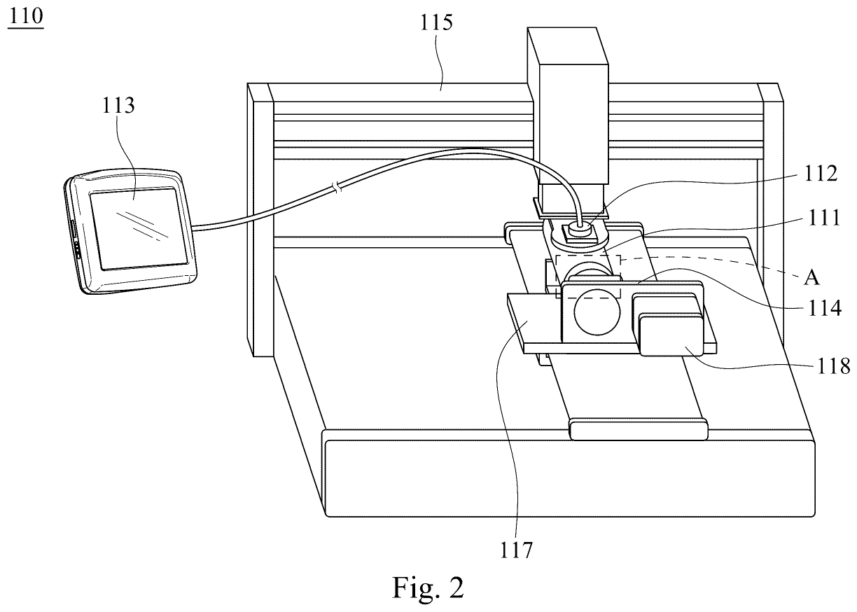

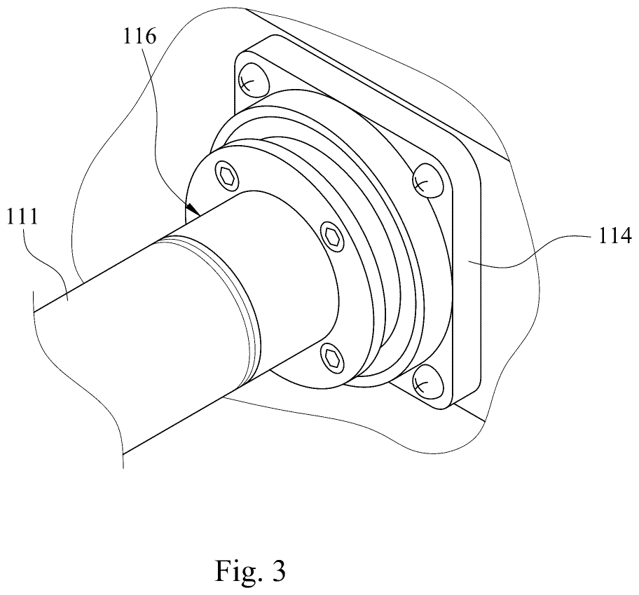

Reference is made to FIG. 1 to FIG. 3, FIG. 1 is a flow chart of a defect detecting method for a sealant product 100 according to one embodiment of the present disclosure, FIG. 2 is a schematic view of an ultrasonic testing system 110 used in the defect detecting method for the sealant product 100 in FIG. 1, and FIG. 3 is an enlarged view of zone A in FIG. 2. In FIG. 1 to FIG. 3, the defect detecting method for the sealant product 100 includes step 101, step 102, step 103 and step 104. The ultrasonic testing system 110 is used to complete the defect detecting method for the sealant product 100, and the ultrasonic testing system 110 includes an ultrasonic system (its reference numeral is omitted), a motion control system 115 and a rotational control system (its reference numeral is omitted). The ultrasonic system includes an ultrasonic probe 112 and an ultrasonic device 113, the ultrasonic probe 112 is connected to the ultrasonic device 113, and the ultrasonic device 113 is configured to generate ultrasonic signals, to receive ultrasonic signals, and to process ultrasonic signals. The rotational control system includes a rotatable seat 114 and a controlling motor 118. The motion control system 115 includes a movable seat 117.

One end of a sealant product 111 is fixed to the rotatable seat 114 before performing the defect detecting method for the sealant product 100. In FIG. 2 and FIG. 3, the end of the sealant product 111 is fixed to the rotatable seat 114 by a fixing element 116, and the rotatable seat 114 is disposed on the motion control system 115. Therefore, the positioning stability of the sealant product 111 can be enhanced, a reference point can be provided, and it is favorable for the reliability and the accuracy of the defect detecting method for the sealant product 100. Moreover, the sealant product 111 is drove to axially rotate by the rotatable seat 114, so that it is beneficial for the detecting integrity of the defect detecting method for the sealant product 100, and blind spots are reduced.

In step 101, a plurality of ultrasonic scans are performed on the sealant product 111 to obtain a set of scanning data, and the set of scanning data includes a plurality of longitudinal sliced data and a plurality of transversely sliced data. The resolution and the accuracy of the set of scanning data can be better through integrating the correspondence between the longitudinal sliced data and the transversely sliced data. Each of the ultrasonic scans includes steps as below. The sealant product 111 is scanned from one end of the sealant product 111 to the other end of the sealant product 111 along a long axis of the sealant product 111 by the ultrasonic probe 112. The sealant product 111 is axially rotated with a rotating angle of 1 degree to 180 degrees. Therefore, the accuracy of the set of scanning data can be adjusted by adjusting the rotating angle. In detail, the ultrasonic probe 112 is physically contacted with a surface of the sealant product 111 and corresponds to the end of the sealant product 111, and the sealant product 111 is scanned from the end of the sealant product 111 to the other end of the sealant product 111 by the ultrasonic probe 112. After that, the ultrasonic probe 112 is moved away from the surface of the sealant product 111, so that the ultrasonic probe 112 is not physically contacted with the surface of the sealant product 111, and the sealant product 111 is axially rotated. Therefore, it is favorable for avoiding the unnecessary wear and tear of the ultrasonic probe 112. Specifically, a slice number of the longitudinal sliced data can be 2 to 360, and a slice number of the transversely sliced data can be 2 to 200. A three dimensional image of the sealant product 111 can be obtained by integrating the longitudinal sliced data and the transversely sliced data, and can be used to assist the positioning applicability of the defect detecting method for the sealant product 100. Preferably, the slice number of the longitudinal sliced data can be 12 to 360. Therefore, the resolution of the defect detecting result of the defect detecting method for the sealant product 100 can be improved. More preferably, the slice number of the longitudinal sliced data can be 24 to 72. Appropriate longitudinal sliced data are beneficial to improve the execution efficiency of the defect detecting method for the sealant product 100, and to ensure the accuracy of the defect detecting method for the sealant product 100. Further, when the sealant product 111 is scanned from the end of the sealant product 111 to the other end of the sealant product 111 along the long axis of the sealant product 111 by the ultrasonic probe 112, the sealant product 111 is moved through moving the movable seat 117 of the motion control system 115. The sealant product 111 is moved relative to the ultrasonic probe 112 so as to complete the scanning of the sealant product 111 by the ultrasonic probe 112 along the long axis of the sealant product 111.

Moreover, a scanning number of the ultrasonic scans can be 2 to 360. Therefore, the accuracy of the set of scanning data can be adjusted by adjusting the scanning number. Specifically, a product of the rotating angle and the scanning number can be 360. The surface of the sealant product 111 is completely scanned by the ultrasonic scans, and it is beneficial to the integrity of the defect detecting result of the defect detecting method for the sealant product 100. Preferably, the rotating angle can be 1 degree to 30 degrees, and the scanning number of the ultrasonic scans can be 12 to 360. Therefore, the resolution of the defect detecting result of the defect detecting method for the sealant product 100 can be improved, and it is beneficial to the accuracy of the defect detecting method for the sealant product 100. More preferably, the rotating angle can be 5 degrees to 15 degrees, and the scanning number of the ultrasonic scans can be 24 to 72. An appropriate combination of the rotating angle and the scanning number is favorable for the execution efficiency of the defect detecting method for the sealant product 100, and to ensure the accuracy and the reliability of the defect detecting method for the sealant product 100.

In detail, an ultrasonic transmission gel can be coated on the surface of the sealant product 111 before performing the ultrasonic scans on the sealant product 111. The ultrasonic transmission gel is favorable for a good contact between the sealant product 111 and the ultrasonic probe 112, and ensuring the ultrasonic transmission efficiency. Furthermore, the ultrasonic transmission gel can include water, glycerol and an acrylic polymer. Water is helpful in the ultrasonic transmission. Glycerol can increase the smoothness of the ultrasonic transmission gel, so that the ultrasonic probe 112 can be easily moved on the surface of the sealant product 111. The acrylic polymer can be used as a thicker, and the acrylic polymer can be a poly acrylic acid.

In step 102, the set of scanning data is standardized to obtain a set of standardized scanning data, and the set of standardized scanning data includes a plurality of standardized longitudinal sliced data and a plurality of standardized transversely sliced data. Therefore, the influence of scale units can be eliminated, and it is beneficial to the data comparison and the application.

In step 103, the set of standardized scanning data is analyzed by a principal component analysis to obtain a covariance matrix. The principal component analysis can reduce the interference of data noises, further highlight detecting signals, and reduce variables during processing data so as to shorten the calculating time of computers. Moreover, a principal component content of the principal component analysis can include at least two principal components. Therefore, it is favorable for the accuracy of the defect detecting method for the sealant product 100. Specifically, the principal component content of the principal component analysis is determined according to the number of retained measures of variation, as the cumulative contribution rate of the principal component analysis reaches the predetermined threshold, and the selection of principal components can be stopped. When the cumulative contribution rate of the at least two principal components reaches 90%, it means the at least two principal components can represent 90% of the information in the original data. The appropriate principal component content can retain more key information of the original data, and it is favorable for the accuracy of the analysis. Preferably, the principal component content of the principal component analysis can include 10 principal components. Therefore, the accuracy of the analysis can be improved, and the analysis efficiency of the defect detecting method for the sealant product 100 can be ensured.

Specifically, the principal component analysis is a statistical technique for reducing the complexity of high-dimensional data, and preserving potential trends and patterns of the high-dimensional data. The original correlated variables are converted to principal components by the principal component analysis, and the principal components are arranged sequentially so as to progressively maximize the variables in the data. The principal component analysis is widely used in exploratory data analysis and the development of forecasting model, and can reduce the computational complexity, remove noises, enhance the interpretability and maximally reduce the information loss.

In step 104, a determinant of the covariance matrix is compared with a determinant of a standard so as to obtain a defect detecting result. The principal component analysis is used to distinguish normal data from abnormal data, and to further analyze the abnormal data. Therefore, it is favorable to identify locations of defects.

### <Defect Positioning Method>

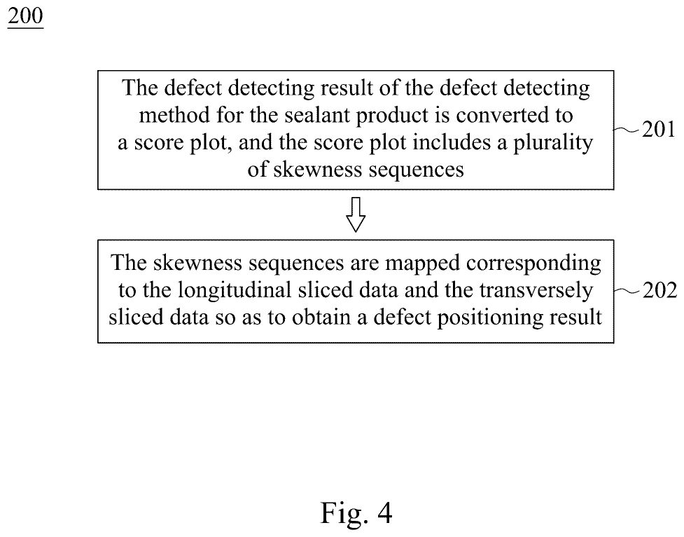

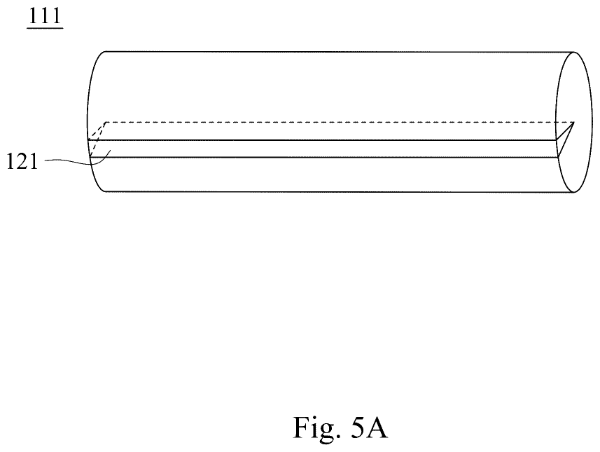

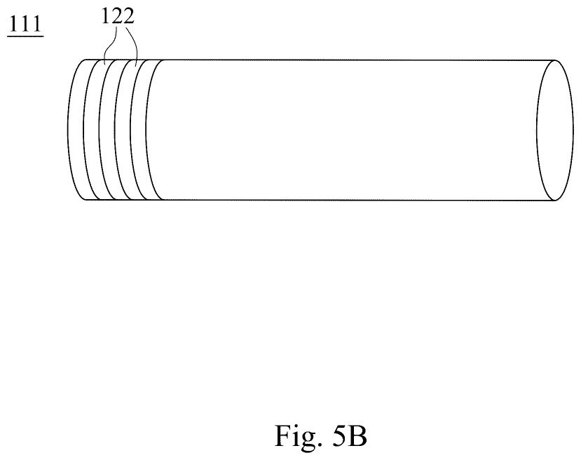

Reference is made to FIG. 4 to FIG. 5B, FIG. 4 is a flow chart of a defect positioning method 200 according to another embodiment of the present disclosure, FIG. 5A is a schematic view of the sealant product 111 and longitudinal slices 121, and FIG. 5B is a schematic view of the sealant product 111 and transversely slices 122. The defect positioning method 200 includes step 201 and step 202.

In step 201, the defect detecting result of the aforementioned defect detecting method for the sealant product 100 is converted to a score plot, and the score plot includes a plurality of skewness sequences. In step 202, the skewness sequences are mapped corresponding to the longitudinal sliced data and the transversely sliced data so as to obtain a defect positioning result. Therefore, it is favorable for the positioning accuracy of the defect positioning method 200.

In FIG. 5A, the sealant product 111 can be imaged as being composed of a plurality of longitudinal slices 121. The longitudinal sliced data corresponds to the longitudinal slices 121, a cross section of each of the longitudinal slices 121 is in a shape of sector, and a long axis of each of the longitudinal slices 121 is parallel to the long axis of the sealant product 111. In FIG. 5B, the sealant product 111 can be imaged as being composed of a plurality of transversely slices 122. The transversely sliced data corresponds to the transversely slices 122, and a total thickness of the transversely slices 122 is equal to a length of the sealant product 111.

The following specific embodiments further illustrate the present disclosure for those with ordinary skill in the technical field to utilize and realize the present disclosure without excessive interpretation. These embodiments should not limit the scope of the present disclosure, but illustrate how to implement the materials and methods of the present disclosure.

### Experimental Example

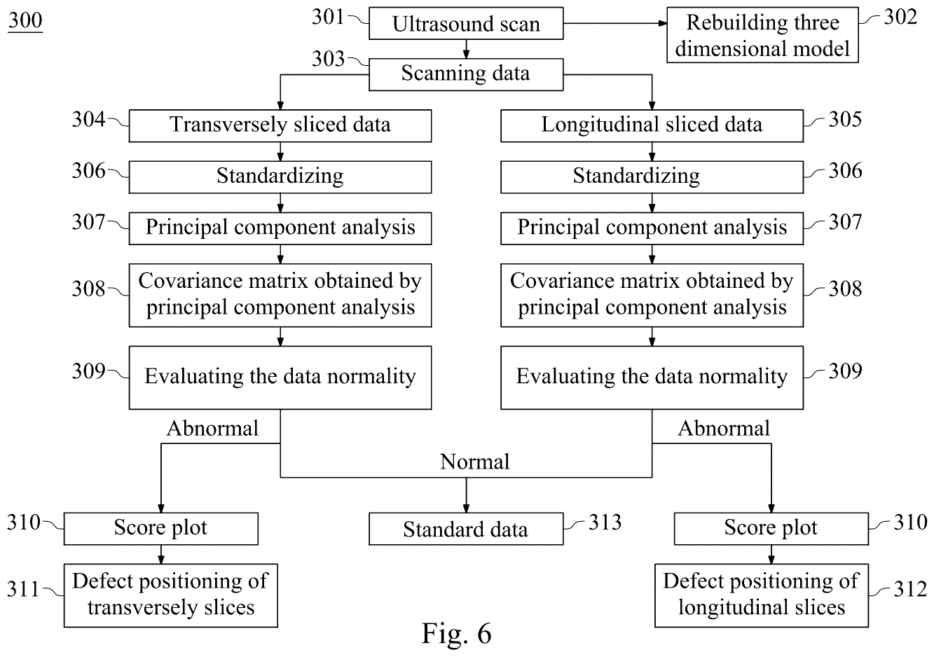

Experimental samples of the present disclosure are analyzed by a flow chart of data analysis 300 according to the defect detecting method for the sealant product and the defect positioning method of the present disclosure. Reference is made to FIG. 6, which is the flow chart of data analysis 300 according to the defect detecting method for the sealant product and the defect positioning method. The flow chart of data analysis 300 includes ultrasonic scan 301, rebuilding three dimensional model 302, scanning data 303, transversely sliced data 304, longitudinal sliced data 305, standardizing 306, principal component analysis 307, covariance matrix obtained by principal component analysis 308, evaluating the data normality 309, score plot 310, defect positioning of transversely slices 311, defect positioning of longitudinal slices 312 and standard data 313, wherein the scanning result of the ultrasonic scans 301 can be used in rebuilding three dimensional model 302.

Moreover, the ultrasonic scans 301 are sorted sequentially and converted corresponding to the three dimensional spatial coordinates in rebuilding three dimensional model 302, and the three dimensional spatial coordinates are the XYZ spatial coordinates. Every datum is given the corresponding coordinate, then the corresponding coordinate is further converted to the original spatial coordinate, standard two dimensional rotation transformation formulas are used, and the standard two-dimensional rotation transformation formulas are represented by formula (i) and formula (ii):

x′=cos(θ)×x−sin(θ)×y formula (i);

y′=sin(θ)×x+cos(θ)×y formula (ii).

x′ and y′ are rotated coordinates, x and y are original coordinates before rotating, and θ is a coordinate rotating angle.

In detail, the sealant product used in the present disclosure is a commercial silicone sealant product (DOWSIL™ N2 Plus) as a standard sealant product (hereinafter referred to as Standard). Air is respectively injected into commercial silicone sealant products to prepare Experimental example 1 (hereinafter referred to as Experimental example 1), Experimental example 2 (hereinafter referred to as Experimental example 2), Experimental example 3 (hereinafter referred to as Experimental example 3) and Experimental example 4 (hereinafter referred to as Experimental example 4). The preparation conditions of Standard, Experimental example 1, Experimental example 2, Experimental example 3 and Experimental example 4 are listed in Table 1.

TABLE 1

| | | Experi- | Experi- | Experi- | Experi- |
|---|---|---|---|---|---|
| | | mental | mental | mental | mental |
| | Standard | example 1 | example 2 | example 3 | example 4 |
| Volume | N/A | 10 | 5 | 15 | 10 |
| of air | | | | | |
| injection | | | | | |
| (ml) | | | | | |
| Location | N/A | Bottom | Bottom | Side | Top end |
| of air | | end | end | | |
| injection | | | | | |

Standard, Experimental example 1, Experimental example Experimental example 3 and Experimental example 4 are respectively analyzed by the defect detecting method for the sealant product of the present disclosure, which includes steps as follows. One end of a sealant product is fixed. A plurality of ultrasonic scans 301 are performed on the sealant product to obtain a set of scanning data 303, and the set of scanning data 303 includes a plurality of longitudinal sliced data 305 and a plurality of transversely sliced data 304. The set of scanning data 303 is processed with standardizing 306 to obtain a set of standardized scanning data, and the set of standardized scanning data includes a plurality of standardized longitudinal sliced data and a plurality of standardized transversely sliced data. The set of standardized scanning data is analyzed to obtain a covariance matrix obtained by principal component analysis 308, and a determinant of the covariance matrix is compared with a determinant of a standard so as to obtain a defect detecting result.

Specifically, the most significant change in data can be determined by the principal component analysis 307, and the most significant change is the first principal component that corresponds and explains the eigenvector with the largest eigenvalue in the data covariance matrix. The subsequent principal components can be calculated with the aforementioned method and should satisfy a limitation condition of being orthogonal to the previous principal component, and the goal is to find a principal component with the second largest variance. The number of the retained principal components is determined according to the size of the retained variance, and each of the principal components transforms the original data into a new orthogonal basis composed of the eigenvectors of the covariance matrix so as to reduce the dimensionality of the original data.

Each of the ultrasonic scans 301 includes step as follows. The sealant product is scanned from one end of the sealant product to the other end of the sealant product along a long axis of the sealant product by an ultrasonic probe. The sealant product is axially rotated with a rotating angle of 5 degrees. The ultrasonic probe (C606-RB, Olympus, USA) in the pulse-echo mode is used in the present disclosure, the ultrasonic frequency of the ultrasonic probe is 2.25 MHz, and the penetration depth is 23 mm to 25 mm. Moreover, a scanning number of the ultrasonic scans 301 is 72, a length of the sealant product is 150 mm, a slice number of the longitudinal sliced data 305 is 72, and a slice number of the transversely sliced data 304 is 150. In detail, each of the longitudinal sliced data 305 corresponds to a matrix of 150×134, and results in a total of 72 slices. Each of the transversely sliced data 304 includes 9648 data points.

In FIG. 6, the defect positioning method of the present disclosure is performed to respectively position defects in Experimental example 1, Experimental example 2, Experimental example 3 and Experimental example 4. The defect detecting results of Experimental example 1, Experimental example 2, Experimental example 3 and Experimental example 4 with evaluating the data normality 309 are respectively converted to score plots 310, and each of the score plots 310 includes a plurality of skewness sequences. The standard data 313 are set as the normal value, and the skewness sequences corresponding to the longitudinal sliced data 305 and the transversely sliced data 304 are set as abnormal values to position defects so as to obtain a defect positioning result. The defect positioning result includes defect positioning of transversely slices 311 and defect positioning of longitudinal slices 312.

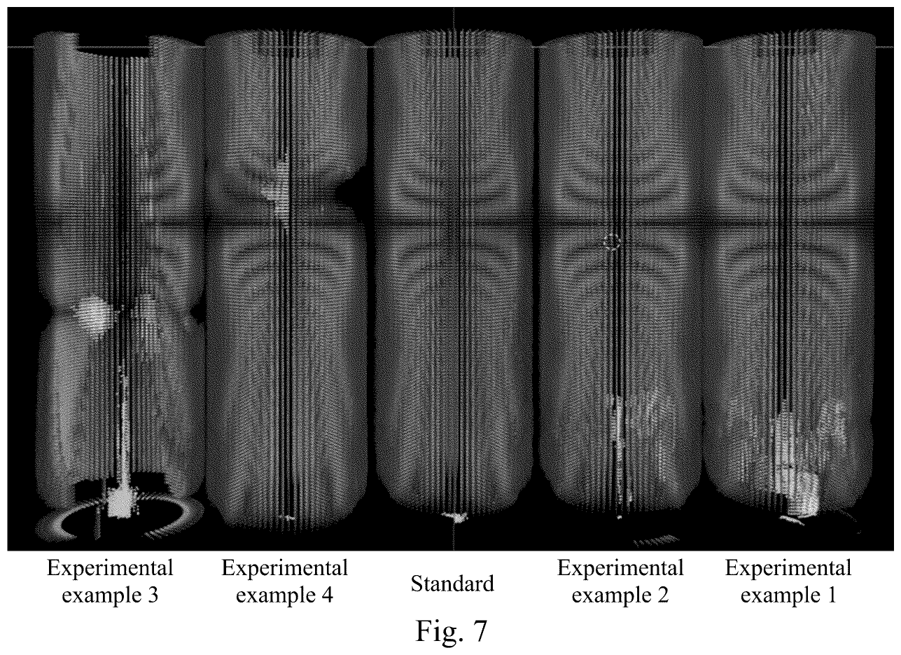

Reference is made to FIG. 7, which is three dimensional images of Standard, Experimental example 1, Experimental example 2, Experimental example 3 and Experimental example 4. In FIG. 7, no defects are found in the three dimensional image of Standard. The three dimensional images of Experimental example 1, Experimental example 2, Experimental example 3 and Experimental example 4 show that the defect is found at the bottom end of Experimental example 1, the defect is found at the side of Experimental example 3, and the defect is found at the top end of Experimental example 4. It should be noted that the three dimensional image of Experimental example 2 is similar to the three dimensional image of Standard, and it indicates that the defect caused by 5 ml air injection cannot be identify by the three dimensional image.

Determinants of the longitudinal sliced data 305 of Standard, Experimental example 1, Experimental example 2, Experimental example 3 and Experimental example 4 are listed in Table 2.

TABLE 2

| | | Experimental | Experimental | Experimental | Experimental |
|---|---|---|---|---|---|
| | standard | example 1 | example 2 | example 3 | example 4 |
| 1^{st} defect | 7.45 × 10²⁴ | 7.6 × 10²⁵ | 3.61 × 10²⁵ | 3.15 × 10²⁶ | 3.35 × 10²⁵ |
| detecting | | | | | |
| result | | | | | |
| 2^{nd} defect | 7.33 × 10²⁴ | 4.53 × 10²⁵ | 4.07 × 10²⁵ | 1.37 × 10²⁶ | 2.20 × 10²⁵ |
| detecting | | | | | |
| result | | | | | |
| 3^{rd} defect | 1.43 × 10²⁵ | 5.43 × 10²⁵ | 4.99 × 10²⁵ | 1.62 × 10²⁶ | 2.86 × 10²⁵ |
| detecting | | | | | |
| result | | | | | |

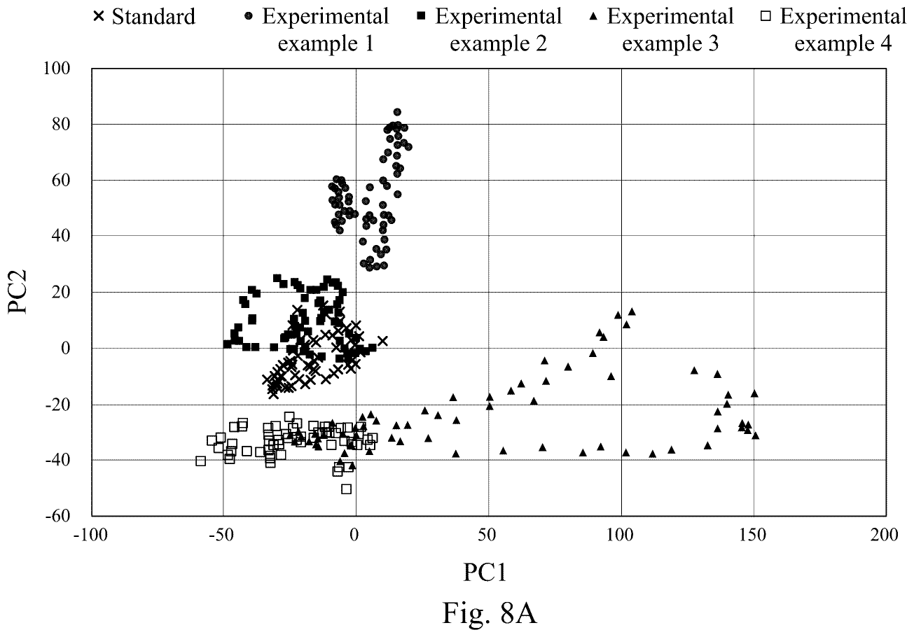

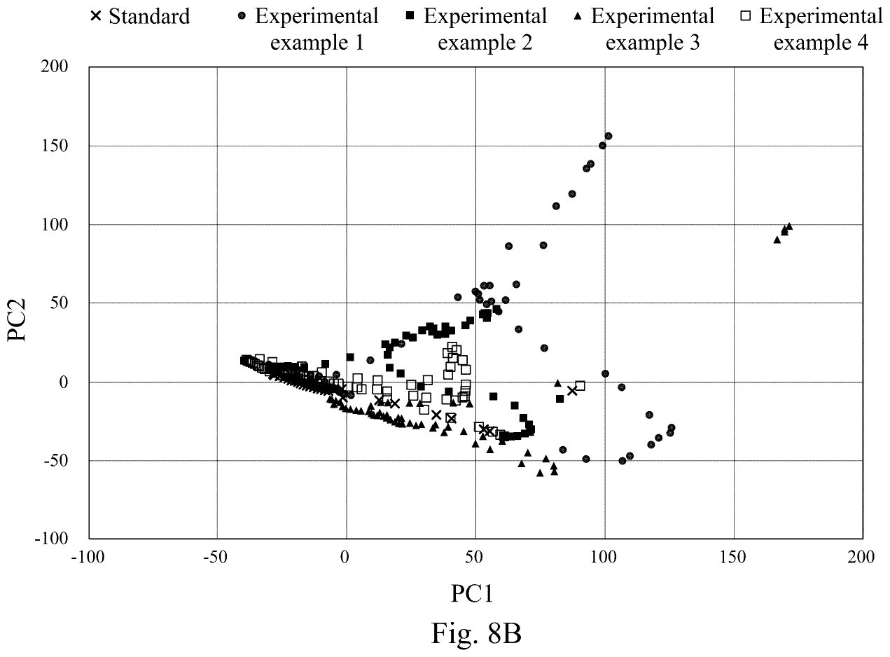

In Table 2, the determinants of the longitudinal sliced data 305 of Experimental example 1, Experimental example 2, Experimental example 3 and Experimental example 4 are higher than the determinant of Standard. It indicates that the variations of Experimental example 1, Experimental example 2, Experimental example 3 and Experimental example 4 are higher than Standard. Reference is made to FIG. 8A, which is a score plot 310 of the longitudinal sliced data 305 of Standard, Experimental example 1, Experimental example 2, Experimental example 3 and Experimental example 4, the horizontal axis represents the first principal component (PC1), and the vertical axis represents the second principal component (PC2). In FIG. 8A, the data dispersions of Experimental example 1, Experimental example 2, Experimental example 3 and Experimental example 4 are larger than the data dispersion of Standard.

Determinants of the transversely sliced data 304 of Standard, Experimental example 1, Experimental example 2, Experimental example 3 and Experimental example 4 are listed in Table 3.

TABLE 3

| | | Experimental | Experimental | Experimental | Experimental |
|---|---|---|---|---|---|
| | standard | example 1 | example 2 | example 3 | example 4 |
| 1^{st} defect | 5.49 × 10²¹ | 3.10 × 10²⁴ | 3.29 × 10²³ | 5.41 × 10²⁴ | 8.51 × 10²² |
| detecting | | | | | |
| result | | | | | |
| 2^{nd} defect | 4.32 × 10²¹ | 2.72 × 10²⁴ | 2.20 × 10²³ | 2.89 × 10²⁴ | 8.25 × 10²² |
| detecting | | | | | |
| result | | | | | |
| 3^{rd} defect | 4.39 × 10²¹ | 2.62 × 10²⁴ | 2.39 × 10²³ | 3.97 × 10²³ | 5.64 × 10²² |
| detecting | | | | | |
| result | | | | | |

In Table 3, the determinants of the transversely sliced data 304 of Experimental example 1, Experimental example 2, Experimental example 3 and Experimental example 4 are higher than the determinant of Standard. It indicates that the variations of Experimental example 1, Experimental example 2, Experimental example 3 and Experimental example 4 are higher than Standard. Reference is made to FIG. 8B, which is a score plot 310 of the transversely sliced data 304 of Standard, Experimental example 1, Experimental example 2, Experimental example 3 and Experimental example 4, the horizontal axis represents the first principal component, and the vertical axis represents the second principal component. In FIG. 8B, the data dispersions of Experimental example 1, Experimental example 2, Experimental example 3 and Experimental example 4 are larger than the data dispersion of Standard. The result of the score plot 310 of the transversely sliced data 304 of Standard, Experimental example 1, Experimental example 2, Experimental example 3 and Experimental example 4 is consistent with the score plot 310 of the longitudinal sliced data 305 of Standard, Experimental example 1, Experimental example 2, Experimental example 3 and Experimental example 4. Accordingly, the defect detecting result can be obtained by the defect detecting method for the sealant product of the present disclosure without destructing samples. In FIG. 7, FIG. 8A and FIG. 8B, the analysis result of the principal component analysis 307 is more sensitive than the three dimensional image. The three dimensional image of Experimental example 2 with 5 ml air injection is similar to the three dimensional image of Standard. However, the defect detecting method for the sealant product of the present disclosure uses the principal component analysis 307 to enhance the data interpretability, and to identify the defect detecting result of Experimental example 2. Therefore, it is favorable for improving the analysis accuracy and ensuring the analysis efficiency.

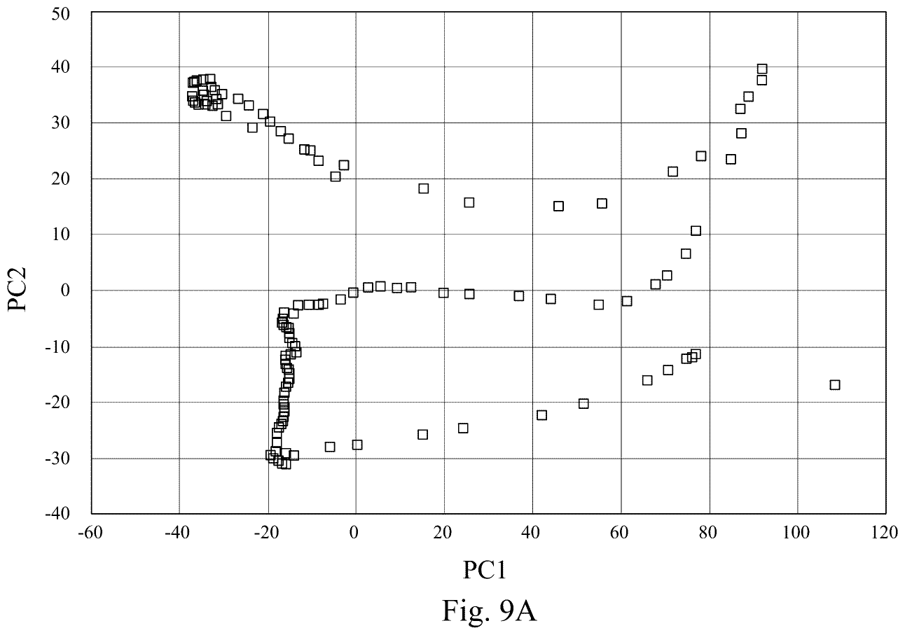

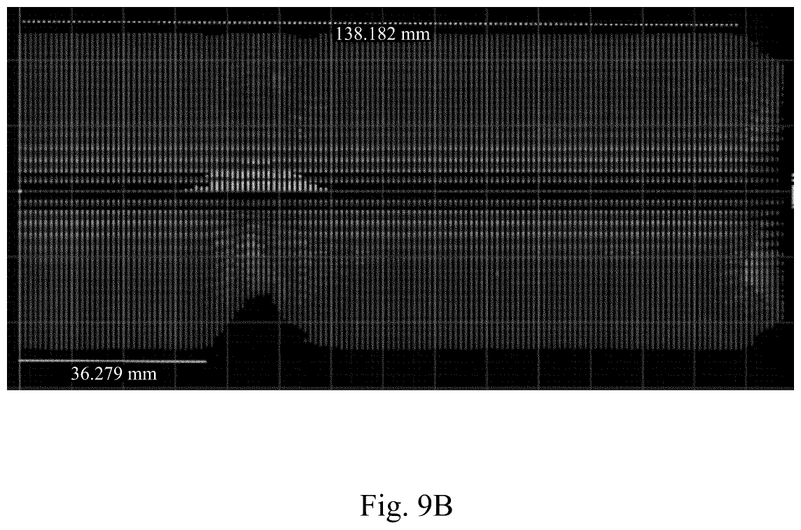

Reference is made to FIG. 9A and FIG. 9B, FIG. 9A is a score plot 310 of the transversely sliced data 304 according to Experimental example 4 in FIG. 8B, and FIG. 9B is a partial enlarged view of the three dimensional image according to Experimental example 4 in FIG. 7. In FIG. 9A and FIG. 9B, the defect location in the three dimensional image of Experimental example 4 corresponds to the changes in the score plot 310. The defect location in the abnormal data can be ensured by combining the score plot 310 and the spatial information. Therefore, the defect positioning method of the present disclosure can efficiently position defects so as to obtain a reliable defect positioning result.

In conclusion, in the defect detecting method for the sealant product of the present disclosure, the ultrasonic scans are performed to obtain the set of scanning data, the set of scanning data is standardized to obtain the set of standardized scanning data, so that the influence of scale units can be eliminated, and it is beneficial to the data comparison. The set of standardized scanning data is analyzed by the principal component analysis to obtain the covariance matrix, and the determinant of the covariance matrix is compared with the determinant of the standard so as to obtain the defect detecting result. The principal component analysis can reduce the interference of data noises, and further highlight detecting signals. Moreover, the defect detecting result is converted to the score plot, and the score plot includes a plurality of skewness sequences. The skewness sequences are mapped corresponding to the longitudinal sliced data and the transversely sliced data so as to obtain the defect positioning result. Therefore, it is favorable for the positioning accuracy of the defect positioning method. The defect detecting method for the sealant product and the defect positioning method of the present disclosure can efficiently positon defects without damaging product and losing material, and it is favorable for ensuring the reliability of the quality inspection.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A defect detecting method for a sealant product, comprising:
performing a plurality of ultrasonic scans on the sealant product to obtain a set of scanning data, wherein the set of scanning data comprises a plurality of longitudinal sliced data and a plurality of transversely sliced data, and each of the ultrasonic scans comprises:
scanning the sealant product from one end of the sealant product to the other end of the sealant product along a long axis of the sealant product by an ultrasonic probe; and
rotating the sealant product axially with a rotating angle of 1 degree to 180 degrees;
standardizing the set of scanning data to obtain a set of standardized scanning data, wherein the set of standardized scanning data comprises a plurality of standardized longitudinal sliced data and a plurality of standardized transversely sliced data;
analyzing the set of standardized scanning data by a principal component analysis to obtain a covariance matrix; and
comparing a determinant of the covariance matrix with a determinant of a standard so as to obtain a defect detecting result.

2. The defect detecting method for the sealant product of claim 1, wherein a principal component content of the principal component analysis comprises at least two principal components.

3. The defect detecting method for the sealant product of claim 1, wherein a slice number of the longitudinal sliced data is 2 to 360.

4. The defect detecting method for the sealant product of claim 3, wherein the slice number of the longitudinal sliced data is 12 to 360.

5. The defect detecting method for the sealant product of claim 4, wherein the slice number of the longitudinal sliced data is 24 to 72.

6. The defect detecting method for the sealant product of claim 1, wherein a slice number of the transversely sliced data is 2 to 200.

7. The defect detecting method for the sealant product of claim 1, wherein the rotating angle is 1 degree to 30 degrees.

8. The defect detecting method for the sealant product of claim 7, wherein the rotating angle is 5 degrees to 15 degrees.

9. The defect detecting method for the sealant product of claim 1, wherein a scanning number of the ultrasonic scans is 2 to 360.

10. The defect detecting method for the sealant product of claim 9, wherein the scanning number of the ultrasonic scans is 12 to 360.

11. The defect detecting method for the sealant product of claim 10, wherein the scanning number of the ultrasonic scans is 24 to 72.

12. The defect detecting method for the sealant product of claim 9, wherein a product of the rotating angle and the scanning number is 360.

13. The defect detecting method for the sealant product of claim 1, wherein an ultrasonic transmission gel is coated on a surface of the sealant product before performing the ultrasonic scans on the sealant product.

14. The defect detecting method for the sealant product of claim 13, wherein the ultrasonic transmission gel comprises water, glycerol and an acrylic polymer.

15. A defect positioning method, comprising:
converting the defect detecting result of the defect detecting method for the sealant product of claim 1 to a score plot, wherein the score plot comprises a plurality of skewness sequences; and
mapping the skewness sequences corresponding to the longitudinal sliced data and the transversely sliced data so as to obtain a defect positioning result.
